(19) United States
(12) Patent Application Publication
(10) Pub. No.: US 2026/0084283 A1
(43) Pub. Date: Mar. 26, 2026

(54) APPARATUS, SYSTEM, AND METHOD OF A SAFETY-BASED MULTI-ACTUATOR DRIVER FOR A MOBILE ROBOT

(71) Applicant: INTEL CORPORATION, Santa Clara, CA (US)

(72) Inventors: Mark Vaynberg, Petah Tikva (IL); Dan Horovitz, Rishon Lezion (IL); Efraim Vitzrabin, Kiryat Ono (IL); Gregory Heifets, Rehovot (IL); Arttu Heinala, Tampere (FI); Antti Paajanen, Ruutana (FI); Aviram Gur, Givat Shmuel (IL); Ben Rubovitch, Modi’in-Maccabim-Reut (IL)

(73) Assignee: INTEL CORPORATION, Santa Clara, CA (US)

(21) Appl. No.: 18/898,537

(22) Filed: Sep. 26, 2024

(51) Int. Cl. B25J 5/00; B25J 9/16; B25J 13/08

(52) U.S. Cl. CPC B25J 5/007; B25J 9/1674; B25J 13/08

(57) ABSTRACT

For example, a safety-based multi-actuator driver may be configured to drive a plurality of actuators of a plurality of wheels of a mobile robot. For example, the safety-based multi-actuator driver may include one or more safety-sensor inputs to receive safety-sensor information from one or more safety sensors of the mobile robot; a plurality of driver outputs to provide a plurality of actuator-drive outputs to drive the plurality of actuators; and a plurality of monitoring inputs to receive actuator monitoring information corresponding to a functionality of the plurality of actuators. For example, the safety-based multi-actuator driver may include a controller to control the plurality of actuator-drive outputs for a controlled safety-stop of the mobile robot based on a sensor-based event identified based on the safety-sensor information, and to configure the plurality of actuator-drive outputs for the controlled safety-stop based on an actuator malfunction event identified based on the actuator monitoring information.

### BACKGROUND

Mobile robots may include automatic machines, which may have the capability to move around in their environment.

In one example, a mobile robot may be implemented as an Automated Guided Vehicle (AGV), which may be configured to follow fixed paths or tracks, for example, for transportation of products.

In another example, a mobile robot may be implemented as an Autonomous Mobile Robot (AMR), which may be configured to operate autonomously and to navigate in an uncontrolled environment, e.g., without the need for fixed paths or tracks.

For example, a mobile robot may include one or more motors to drive one or more wheels of the mobile robot.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a mobile robot, in accordance with some demonstrative aspects.

FIG. 2 is a schematic block diagram illustration of a system including a safety-based multi-actuator driver, in accordance with some demonstrative aspects.

FIG. 3 is a schematic flow-chart illustration of a method of a controlled safety-stop of a mobile robot, in accordance with some demonstrative aspects.

FIG. 4 is a schematic illustration of a system implementing an actuator driver redundancy architecture, in accordance with some demonstrative aspects.

FIG. 5 is a schematic illustration of a system implementing an actuator driver redundancy architecture, in accordance with some demonstrative aspects.

FIG. 6 is a schematic illustration of a power source redundancy architecture, in accordance with some demonstrative aspects.

FIG. 7 is a schematic illustration of a power rail redundancy architecture, in accordance with some demonstrative aspects.

FIG. 8 is a schematic illustration of a controller redundancy architecture, in accordance with some demonstrative aspects.

FIG. 9 is a schematic illustration of a half-bridge driver redundancy architecture, in accordance with some demonstrative aspects.

FIG. 10 is a schematic flow-chart illustration of a method of a safety-based multi-actuator driver, in accordance with some demonstrative aspects.

FIG. 11 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [. . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage among others, or any combination thereof. Registers, shift registers, processor registers, data buffers, among others, are also embraced herein by the term memory. The term “software” may be used to refer to any type of executable instruction and/or logic, including firmware, which may be stored, for example, by a memory.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

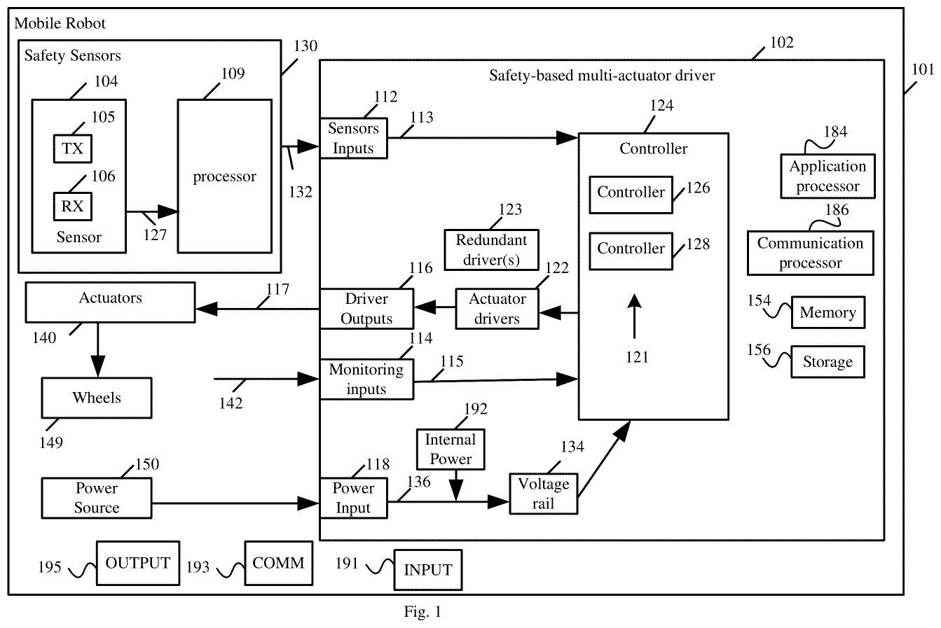

Reference is now made to FIG. 1, which schematically illustrates a mobile robot 101, in accordance with some demonstrative aspects.

In some demonstrative aspects, mobile robot 101 may be configured to carry one or more objects, e.g., from one place to another.

In other aspects, mobile robot 101 may be configured to perform one or more other additional or alternative operations and/or functionalities.

In some demonstrative aspects, the mobile robot 101 may include an Autonomous Mobile Robot (AMR), which may be configured to operate autonomously and to navigate in an uncontrolled environment, e.g., without the need for fixed paths or tracks.

In other aspects, the mobile robot 101 may include an Automated Guided Vehicle (AGV), which may be configured to follow fixed paths or tracks, for example, for transportation of products.

In other aspects, the mobile robot 101 may include any other suitable type of robot, which may have the capability to move around in an environment.

In some demonstrative aspects, mobile robot 101 may include one or more safety sensors 130, which may be configured to sense an environment of the mobile robot 101.

In some demonstrative aspects, the one or more safety sensors 130 may be configured to provide safety-sensor information 132, for example, during operation and/or movement of the mobile robot 101, e.g., as described below.

In some demonstrative aspects, the safety-sensor information 132 may include a safety event detection to indicate, e.g., identify, a safety event. In one example, a safety sensor 130 may generate the safety-sensor information 132 including the safety event detection, for example, based on detection of a hazard, e.g., as described below.

In other aspects, the safety-sensor information 132 may include any other additional or alternative information.

In some demonstrative aspects, the one or more safety sensors 130 may include at least one sensor 104, which may be configured to provide sensor information 127 corresponding to the environment of the mobile robot 101.

In some demonstrative aspects, sensor 104 may include a light-based sensor 104, e.g., as described below.

In some demonstrative aspects, the light-based sensor 104 may include a Light Detection and Ranging (LiDAR) sensor.

In other aspects, the light-based sensor 104 may include any other additional type of light-based sensor configured to generate light-based sensor information based on sensed and/or detected light.

In some demonstrative aspects, as shown in FIG. 1, light-based sensor 104 may include a light transmitter (Tx) 105 and a light receiver (Rx) 106.

In some demonstrative aspects, light transmitter 105 may include one or more elements, for example, a light source, optic elements, and/or one or more other elements, configured to generate light signals to be emitted by the light-based sensor 104.

In some demonstrative aspects, the one or more safety sensors 130 may include a processor 109.

In some demonstrative aspects, processor 109 may include, or may be implemented, partially or entirely, by circuitry and/or logic, e.g., one or more processors including circuitry and/or logic, memory circuitry and/or logic. Additionally or alternatively, one or more functionalities of processor 109 may be implemented by logic, which may be executed by a machine and/or one or more processors, e.g., as described below.

In some demonstrative aspects, for example, processor 109 may provide digital transmit data values to the light-based sensor 104.

In some demonstrative aspects, light receiver 106 may include one or more elements, for example, one or more photo detectors, one or optical elements and/or one or more other elements, configured to detect and/or process, light signals received by light receiver 106.

In some demonstrative aspects, for example, light receiver 106 may be configured to convert a detected light signal into digital reception data values based on the detected light. For example, light-based sensor 104 may provide the sensor information 127 to the processor 109, for example, based on the digital reception data values.

In some demonstrative aspects, the one or more safety sensors 130 may include any other additional or alternative type of sensor 104, e.g., instead of the light-based sensor, or in addition to the light-based sensor.

In one example, the one or more safety sensors 130 may include an image-based sensor 104, which may utilize one or more image-capturing devices, e.g., cameras. For example, the image-based sensor 104 may include one or more cameras, which may be configured to capture images from an environment of the mobile robot 101. For example, the image-based sensor 104 may be configured to provide the sensor information 127 to the processor 109, for example, based on the images captured by the cameras.

In another example, the one or more safety sensors 130 may include a radar-based sensor 104, which may utilize one or more radar devices. For example, the radar-based sensor 104 may include one or more radar transmitters 105, which may be configured to transmit radar signals, and one or more radar receivers 106, which may be configured to receive radar signals, for example, based on the transmitted radar signals. For example, the radar-based sensor 104 may be configured to provide the sensor information 127 to the processor 109, for example, based on the received radar signals.

In some demonstrative aspects, processor 109 may be configured to process the sensor information 127 from one or more sensos 104, for example, to detect one or more objects, e.g., in an environment of the mobile robot 101.

In one example, processor 109 may be configured to process the sensor information 127, for example, to detect the presence of one or more objects within a safety zone defined for the mobile robot 101.

In another example, processor 109 may be configured to process the sensor information 127, for example, to determine safety-sensor information 132 including one or more of range, speed, direction, and/or any other information, of one or more objects, e.g., with respect to the mobile robot 101.

In some demonstrative aspects, processor 109 may be configured to determine the safety-sensor information 132, for example, based on the sensor information 127, e.g., as described below.

In some demonstrative aspects, processor 109 may be configured to monitor the sensor information 127, for example, to detect a hazard in an environment of the mobile robot 101, e.g., in a safety zone defined for the mobile robot 101, for example, during movement of the mobile robot 101.

In some demonstrative aspects, processor 109 may be configured to generate an alert, for example, based on a determination that the hazard is detected in the safety zone of the mobile robot 101. For example, processor 109 may be configured to provide the alert, for example, as part of, or in the form of, the safety-sensor information 132.

In some demonstrative aspects, mobile robot 101 may include a safety-based multi-actuator driver 102, which may be configured to control rotation of a plurality of wheels 149 of the mobile robot 101, e.g., as described below.

In some demonstrative aspects, safety-based multi-actuator driver 102 may be implemented as part of a safety related system of mobile robot 101, e.g., together with safety sensors 130 and/or one or more additional or alternative safety components.

In some demonstrative aspects, safety-based multi-actuator driver 102 may be configured to control the plurality of wheels 149 of the mobile robot 101, for example, by driving a plurality of actuators 140 of the plurality of wheels of the mobile robot 101.

In some demonstrative aspects, safety-based multi-actuator driver 102 may be configured to generate a plurality of actuator-drive outputs 117 to drive the plurality of actuators 140, e.g., as described below.

For example, an actuator 140 may include a motor, which may be driven by an actuator-drive output 117 from safety-based multi-actuator driver 102, e.g., to rotate a wheel 149, e.g., as described below.

In some demonstrative aspects, safety-based multi-actuator driver 102 may be configured to control rotation of the plurality of wheels 149, for example, based on the safety-sensor information 132, e.g., as described below.

In some demonstrative aspects, safety-based multi-actuator driver 102 may be configured to generate the plurality of actuator-drive outputs 117, for example, based on the safety-sensor information 132, e.g., as described below.

In some demonstrative aspects, safety-based multi-actuator driver 102 may be configured to generate the plurality of actuator-drive outputs 117, for example, to control the plurality of actuators 140, to control the speed of the wheels 149, e.g., as described below.

In one example, safety-based multi-actuator driver 102 may be configured to generate the plurality of actuator-drive outputs 117, for example, to control a speed of the mobile robot 101, for example, based on whether or not an object is detected within a safety zone defined for the mobile robot 101.

For example, safety-based multi-actuator driver 102 may be configured to generate the plurality of actuator-drive outputs 117, for example, to cause the mobile robot 101 to begin moving or to increase speed, for example, based on a determination that there is no object detected within the safety zone defined for the mobile robot 101.

For example, safety-based multi-actuator driver 102 may be configured to generate the plurality of actuator-drive outputs 117, for example, to cause the mobile robot 101 to slow down, or to stop, for example, based on a determination that an object is detected within the safety zone defined for the mobile robot 101.

In some demonstrative aspects, safety-based multi-actuator driver 102 may be configured, for example, to configure the plurality of actuator-drive outputs 117, for a controlled safety stop of the mobile robot 101.

In some demonstrative aspects, safety-based multi-actuator driver 102 may be configured to trigger the controlled safety stop of the mobile robot 101, for example, based on the safety-sensor information 132.

In some demonstrative aspects, safety-based multi-actuator driver 102 may be configured to trigger the controlled safety stop of the mobile robot 101, for example, based on a safety event detection, which may be based on the sensor information 127 from the one or more sensors 104 of the mobile robot 101.

For example, safety-based multi-actuator driver 102 may be configured to trigger the controlled safety stop of the mobile robot 101, for example, based on a safety event detection, which may be identified based on the safety-sensor information 132.

In some demonstrative aspects, safety-based multi-actuator driver 102 may be configured to control a controlled safety stop of mobile robot 101, for example, by controlling the plurality of actuators 140 of the plurality of wheels 149 of the mobile robot 101.

In some demonstrative aspects, safety-based multi-actuator driver 102 may be configured, for example, to configure the plurality of actuator-drive outputs 117 to provide a technical solution to support the controlled safety stop of the mobile robot 101, for example, in compliance with one or more functional safety requirements, for example, in accordance with a functional safety protocol or standard, e.g., as described below.

For example, safety-based multi-actuator driver 102 may configure the plurality of actuator-drive outputs 117 to provide a technical solution to support the controlled safety stop of the mobile robot 100, for example, in compliance with functional safety requirements of a functional safety protocol or standard for mobile robots, e.g., as described below.

In some demonstrative aspects, safety-based multi-actuator driver 102 may be configured to monitor the safety-sensor information 132 from one or more safety sensors 130, for example, in accordance with an applicable functional safety standard or protocol, e.g., as described below.

In some demonstrative aspects, safety-based multi-actuator driver 102 may configure the plurality of actuator-drive outputs 117, for example, to perform a controlled safety stop, for example, in case of detection of an abnormal behavior, e.g., which may be defined according to the applicable functional safety standard and/or according to any other criteria, e.g., as described below.

In some demonstrative aspects, safety-based multi-actuator driver 102 may be configured, for example, to configure the plurality of actuator-drive outputs 117, for example, to control a category 1 deceleration-controlled safety stop (SS1-d) of mobile robot 101, e.g., as described below.

In some demonstrative aspects, safety-based multi-actuator driver 102 may be configured, for example, to configure the plurality of actuator-drive outputs 117, for example, to control a safety stop of mobile robot 101 according to an SS1-d function, for example, in compliance with one or more International Electrotechnical Commission (IEC) standards, e.g., including IEC 61800-5-2 (“IEC 61800-5-2:2016, Adjustable speed electrical power drive systems-Part 5-2: Safety requirements—Functional”, 2016); in compliance with one or more International Organization for Standardization (ISO) standards, e.g., including ISO3691-4:2023 (“ISO 3691-4:2023, Industrial trucks—Safety requirements and verification, Part 4: Driverless industrial trucks and their systems, Published (Edition 2, 2023)”); and/or in compliance with one or more American National Standards Institute (ANSI) standards, e.g., including ANSI R15.08 (“ANSI/A3 R15.08-2-2023 American National Standard for Industrial Mobile Robots—Safety Requirements—Part 2: Requirements for IMR system(s) and IMR application(s) (PDF)”).

In some demonstrative aspects, safety-based multi-actuator driver 102 may be configured, for example, to configure the plurality of actuator-drive outputs 117, for example, to cause mobile robot 101 to decelerate to a halt, for example, according to a deceleration profile that satisfies requirements of a functional safety standard, for example, for a controlled safety stop, e.g., SS1-d, a category 2 deceleration-controlled safety stop (SS2-d), or the like.

For example, a category 0 stop may include an uncontrolled stop, where the power to a motor may be safely removed, e.g., immediately, for example, through a mechanical disconnection of the motor and, if necessary, breaking. In one example, the category 0 safety stop may be implemented by a Safe Torque Off (STO) function.

For example, a category 0 stop may not be suitable for many safety applications, e.g., for a safety stop of a mobile robot.

For example, a category 1 safety stop (SS1) may include a controlled stop, where the power of a motor is made available to the motor to achieve the stop. For example, the power may be moved from the motor, e.g., when the stop is achieved. In one example, the controlled stop may utilize an SS1 function to cause a rapid and safe stopping of a drive, for example, by controlling the drive to decelerate autonomously.

For example, a category 1 deceleration-controlled safety stop (SS1-d) may utilize an SS1-d function to initiate and control the motor deceleration rate within set limits to stop the motor. For example, the SS1-d function may initiate the STO function when the motor speed is below a specified limit.

For example, a category 1 ramp-monitored safety stop (SS1-r) may utilize an SS1-r function to initiate and monitor the motor deceleration rate within set limits to stop the motor. For example, the SS1-r function may initiate the STO function when the motor speed is below a specified limit.

For example, a category 1 time-controlled safety stop (SS1-t) may utilize an SS1-t function to initiate the motor deceleration, and to initiate the STO function after an application specific time delay.

In other aspects, safety-based multi-actuator driver 102 may be configured, for example, to configure the plurality of actuator-drive outputs 117, for example, to control an SS1-r stop, an SS1-t stop, and/or any other suitable additional or alternative type of controlled safety stop.

In some demonstrative aspects, the safety-based multi-actuator driver 102 may include a functional-safety-complied controller, which may be in compliance with a functional safety standard for an SS1-d stop, an SS1-r stop, an SS1-t stop, and/or any other suitable additional or alternative type of controlled safety stop for mobile robots, for example, AGVs and/or AMRs, e.g., as described below.

In some demonstrative aspects, the safety-based multi-actuator driver 102 may be configured to provide a technical solution to support implementation of safety certified motor drivers, for example, according to a functional safety standard for an SS1-d stop, an SS1-r stop, an SS1-t stop, and/or any other suitable additional or alternative type of controlled safety stop, e.g., as described below.

For example, in some use cases and/or implementations a mobile robot product may implement multiple components, e.g., multiple separate and/or independent components, which may be provided by multiple vendors, for example, in order to comply with requirements for safety certifying the mobile robot product. However, these multiple components may not always be able to interconnect properly and/or to fully address the safety certification requirements.

For example, a controller, e.g., an additional controller or a dedicated controller, may be implemented to control the safety stop, for example, in case of an implementation of motor drivers, which do not support a controllable safety stop.

In one example, many types of motor drivers may be limited in movement speed, and/or may use big and expensive brakes for stopping, for example, in cases the motor drivers are not certified according to a functional safety standard for an SS1-r stop, an SS1-t stop, and/or any other suitable additional or alternative type of controlled safety stop.

In some demonstrative aspects, the safety-based multi-actuator driver 102 may be configured to provide a technical solution to support safety certification of motor drivers, for example, for a mobile robot, e.g., an AGV or an AMR having two or more wheels 149, for example, corresponding to two or more axes of movement, e.g., as described below.

In some demonstrative aspects, the safety-based multi-actuator driver 102 may be configured to include multiple stages of redundancy, for example, to support certification and braking performance specifications, for example, according to a functional safety standard for a controlled safety stop, e.g., as described below.

In some demonstrative aspects, the safety-based multi-actuator driver 102 may be configured as an integrated safety-based multi-actuator driver, which may be configured to provide a technical solution to fully address safety certification needs, e.g., as described below.

In some demonstrative aspects, the safety-based multi-actuator driver 102 may be configured in the form of an integrated package integrating a controller, for example, a safety Programable Logic Controller (PLC), with several motor drivers to drive the actuators 140, e.g., as described below.

In some demonstrative aspects, the safety-based multi-actuator driver 102 may be configured to provide a technical solution to support one or more safety stop techniques and/or one or more safety functions for braking of the mobile robot 101.

In some demonstrative aspects, the safety-based multi-actuator driver 102 may be configured to provide a technical solution to support braking of a mobile robot, e.g., to a successful stop of the mobile robot, for example, even without any need of using mechanical brakes.

In some demonstrative aspects, the safety-based multi-actuator driver 102 may be configured to provide a technical solution to support a safety stop of mobile robot 101, for example, in case of failures in one or more safety-related components of the mobile robot 101, including, for example, a failure of safety sensors 130 and/or a failure of safety controllers of the mobile robot 101.

In one example, safety sensors and/or safety controllers of a mobile robot may fail, for example, if they stop functioning and/or responding. According to this example, a safety function may shut down everything in a mobile robot, for example, in response to the failure.

In some demonstrative aspects, the safety-based multi-actuator driver 102 may be configured to provide a technical solution to support a safety stop of mobile robot 101, for example, in case of one or more safety-related components of the mobile robot 101, for example, even without immediately shutting down the mobile robot 101.

In some demonstrative aspects, the safety-based multi-actuator driver 102 may be configured to provide a technical solution to support continuous operation of the mobile robot 101, for example, even in case of a failure of safety sensors and/or safety controllers.

For example, the ability to continuous operation of the mobile robot 101, e.g., in case of failure, may provide a technical solution to support faster movement of the mobile robot 101 and/or reduced cost of the mobile robot 101, for example, by reducing the wear out of brakes during a safety stop, or even eliminating the need to use brakes for a safety stop.

In one example, the safety-based multi-actuator driver 102 may be configured to provide a technical solution to support a graceful stopping of the mobile robot 101, for example, even without a need to use brakes. Accordingly, the brakes may have low wear as their use may be only while the mobile robot 101 is standing still, e.g., not at a movement phase.

In some demonstrative aspects, the safety-based multi-actuator driver 102 may be implemented to provide a technical solution to support a centralized processing unit, which may coordinate motor drivers, and/or intervene with motor control algorithms, e.g., as described below.

In some demonstrative aspects, the safety-based multi-actuator driver 102 may be implemented to provide a technical solution to support a faster certification process and/or a cost reduced certification process, for example, by implementing a single integrated component, e.g., the integrated safety-based multi-actuator driver, for example, instead of a minimum three components, for example, including at least two drivers, e.g., one driver per motor, and a safety PLC, which may be limited to monitoring movement and triggering an STO and brakes.

In some demonstrative aspects, the safety-based multi-actuator driver 102 may be implemented to provide a technical solution to support a reduced cost and an increased reliability of mobile robot 101, for example, by reducing a number of failure points, for example, as a number of cables and connectors needed for discrete solutions may be reduced.

In some demonstrative aspects, the safety-based multi-actuator driver 102 may include one or more safety-sensor inputs 112, which may be configured to receive the safety-sensor information 132 from the one or more safety sensors 130 of the mobile robot 101, e.g., as described below.

In some demonstrative aspects, the safety-based multi-actuator driver 102 may include a plurality of driver outputs 116, which may be configured to provide the plurality of actuator-drive outputs 117 to drive the plurality of actuators 140, e.g., as described below.

In some demonstrative aspects, the safety-based multi-actuator driver 102 may include a plurality of monitoring inputs 114, which may be configured to receive actuator monitoring information 142 corresponding to a functionality of the plurality of actuators 140, e.g., as described below.

In some demonstrative aspects, the safety-based multi-actuator driver 102 may include a controller 124, e.g., as described below.

In some demonstrative aspects, controller 124 may include a safety Programable Logic Controller (PLC), a safety Micro Control Unit (MCU), a microprocessor, a Central Processing Unit (CPU), a Digital Signal Processor (DSP), a Field Programmable Gate Array (FPGA), an integrated circuit, an Application Specific Integrated Circuit (ASIC), and/or any other suitable type of controller.

In some demonstrative aspects, controller 124 may include, for or may be implemented, partially or entirely, by circuitry and/or logic, e.g., one or more processors including circuitry and/or logic, memory circuitry and/or logic. Additionally or alternatively, one or more functionalities of controller 124 may be implemented by logic, which may be executed by a machine and/or one or more processors, e.g., as described below.

In some demonstrative aspects, controller 124 may include at least one processor, which may be configured to perform one or more operations and/or functionalities of controller 124, e.g., as described below.

In some demonstrative aspects, controller 124 may include an input to receive input information to be processed by controller 124, e.g., as described below. For example, the input of the controller 124 may include any suitable input interface, input unit, input module, input component, input circuitry, memory interface, memory access unit, memory reader, digital memory unit, bus interface, processor interface, or the like, which may be capable of receiving the input information to be processed by controller 124, e.g., from a memory, a processor, and/or any other suitable component to provide the input information to be processed by controller 124.

In some demonstrative aspects, controller 124 may include an output to provide output information processed by the controller 124, e.g., as described below. For example, the output of the controller 124 may include any suitable output interface, output unit, output module, output component, output circuitry, memory interface, memory access unit, memory writer, digital memory unit, bus interface, processor interface, or the like, which may be capable of outputting the output information from the controller 124 to a memory, a processor, and/or any other suitable component to handle the output information from the controller 124.

In some demonstrative aspects, the safety-based multi-actuator driver 102 may include a storage 156 and/or a memory 154, e.g., to store information processed by controller 124, for example, safety-sensor information 132 from the one or more safety sensors 130, and/or any other data generated by, and/or to be processed by, controller 124.

In some demonstrative aspects, safety-based multi-actuator driver 102 may include, for example, an application processor 184 and/or a communication processor 186, for example, to at least partially implement one or more functionalities of controller 124 and/or to perform communication between controller 124, safety sensors 130, and/or one or more additional elements of mobile robot 101, and/or one or more other devices or systems.

In some demonstrative aspects, mobile robot 101 may include, for example, one or more input units, components, and/or devices 191, for example, sensors, encoders, switches, or the like.

In some demonstrative aspects, mobile robot 101 may include, for example, one or more communication units, components, and/or devices 195, for example, a serial communication interface, a parallel communication interface, a discrete communication interface, a wireless or communication interface, or the like.

In some demonstrative aspects, mobile robot 101 may include, for example, one or more output units, components, and/or devices 193, for example, a display, lights, audio transducers, or the like.

In some demonstrative aspects, controller 124 may be configured to control the plurality of actuator-drive outputs 117 for a controlled safety-stop of the mobile robot 101, for example, based on a sensor-based event 113, which may be indicated, e.g., identified, by the safety-sensor information 132, e.g., as described below.

In some demonstrative aspects, controller 124 may be configured, for example, to configure the plurality of actuator-drive outputs 117 for the controlled safety-stop, for example, based on an actuator malfunction event 115, which may be indicated, e.g., identified, by the actuator monitoring information 142, e.g., as described below.

In some demonstrative aspects, the controlled safety stop may include an SS1-d safety stop.

In other aspects, the controlled safety stop may include any other additional and/or alternative type of a safety stop.

In some demonstrative aspects, the safety-based multi-actuator driver 102 may include a plurality of actuator drivers 122, which may be configured to provide the plurality of actuator-drive outputs 117, e.g., as described below.

In some demonstrative aspects, the safety-based multi-actuator driver 102 may include an integrated safety-based multi-actuator driver 102, e.g., as described below.

In some demonstrative aspects, the integrated safety-based multi-actuator driver 102 may include a package integrating the one or more safety-sensor inputs 112, the plurality of actuator drivers 122, the plurality of driver outputs 116, the plurality of monitoring inputs 114, and the controller 124, e.g., as described below, e.g., as described below.

In some demonstrative aspects, controller 124 may be configured to control the plurality of actuator derivers 122, for example, to provide the plurality of actuator-drive outputs 117, respectively, e.g., as described below.

In some demonstrative aspects, the safety-based multi-actuator driver 102 may include one or more redundant actuator drivers 123, which may be configured to provide the plurality of actuator-drive outputs 117, e.g., as described below.

In some demonstrative aspects, the one or more redundant actuator drivers 123 may include a driver-dedicated backup actuator driver, which may be connected in parallel to an actuator driver 122 of the plurality of actuator drivers 122, e.g., as described below.

In some demonstrative aspects, the driver-dedicated backup actuator driver may be configured to provide a backup actuator-drive output for the actuator driver 122, e.g., as described below.

In some demonstrative aspects, the one or more redundant actuator drivers 123 may include a multi-driver backup actuator driver, which may be connected in parallel to two or more actuator drivers 122 of the plurality of actuator drivers 122, e.g., as described below.

In some demonstrative aspects, the multi-driver backup actuator driver may be configured to provide a backup actuator-drive output for an actuator driver 122 of the two or more actuator drivers 122, e.g., as described below.

In some demonstrative aspects, controller 124 may be configured to monitor a functionality of the plurality of actuator drivers 122, e.g., as described below.

In some demonstrative aspects, controller 124 may be configured, for example, to configure the plurality of actuator-drive outputs 117 for the controlled safety-stop, for example, based on an actuator driver malfunction event corresponding to an actuator driver 122 of the plurality of actuator drivers 122, e.g., as described below.

In some demonstrative aspects, the actuator driver malfunction event may include a half-bridge driver malfunction event corresponding to a half-bridge driver of the actuator driver, e.g., as described below.

In other aspects, the actuator driver malfunction event may include any other additional and/or alternative malfunction event corresponding to the actuator driver 122, e.g., as described below.

In some demonstrative aspects, controller 124 may include a plurality of mutually-monitored controllers 121, e.g., as described below.

In some demonstrative aspects, the plurality of mutually-monitored controllers 121 may include a first controller 126, which may be configured, for example, to configure the plurality of actuator-drive outputs 117 for the controlled safety-stop, for example, based on the sensor-based event 113, e.g., as described below.

In some demonstrative aspects, the first controller 126 may be configured, for example, to configure the plurality of actuator-drive outputs 117 for the controlled safety-stop, for example, based on the actuator malfunction event 115, e.g., as described below.

In some demonstrative aspects, the plurality of mutually-monitored controllers 121 may include a second controller 128, which may be configured to configure the plurality of actuator-drive outputs 117 for the controlled safety-stop, for example, based on the sensor-based event 113, e.g., as described below.

In some demonstrative aspects, the second controller 128 may be configured to configure the plurality of actuator-drive outputs 117 for the controlled safety-stop, for example, based on the actuator malfunction event 115, e.g., as described below.

In some demonstrative aspects, the first controller 126 may be configured to monitor a functionality of the second controller 128, e.g., as described below.

In some demonstrative aspects, the first controller 126 may be configured to configure the plurality of actuator-drive outputs 117 for the controlled safety-stop, for example, based on a malfunction of the second controller 128, e.g., as described below.

In some demonstrative aspects, the second controller 128 may be configured to monitor a functionality of the first controller 126, e.g., as described below.

In some demonstrative aspects, the second controller 128 may be configured to configure the plurality of actuator-drive outputs 117 for the controlled safety-stop, for example, based on a malfunction of the first controller 126, e.g., as described below.

In some demonstrative aspects, the safety-based multi-actuator driver 102 may include a power input 118 to receive power from a power source 150, e.g., as described below.

In one example, power source 150 may include a battery, and power input 118 may include a suitable battery connector or interface to connect to the battery.

In some demonstrative aspects, the safety-based multi-actuator driver 102 may include a plurality of power inputs 118 to receive power from a plurality of power sources 150, for example, to provide a technical solution to support a power fail event of one power source of the plurality of power sources 150.

In one example, the plurality of power inputs 118 may include a plurality of battery connectors to be connected to a plurality of batteries, for example, to support a battery-redundant implementation.

In some demonstrative aspects, controller 124 may be configured to monitor the power input 118, e.g., as described below.

In some demonstrative aspects, controller 124 may be configured to configure the plurality of actuator-drive outputs 117 for the controlled safety-stop, for example, based on a power-source malfunction event corresponding to the power input 118, e.g., as described below.

In some demonstrative aspects, the safety-based multi-actuator driver 102 may include an internal power storage 192, which may be connected in parallel to the power input 118, e.g., as described below.

In some demonstrative aspects, the internal power storage 192 may be configured to store an amount of power sufficient to provide the actuator-drive outputs 117, for example, during the controlled safety-stop, e.g., as described below.

In some demonstrative aspects, the internal power storage 192 may include a capacitor bank, e.g., as described below.

In some demonstrative aspects, the internal power storage 192 may include a Super Capacitor (SC) bank, e.g., as described below.

In other aspects, the internal power storage 192 may include any other additional or alternative type of power storage.

In some demonstrative aspects, the safety-based multi-actuator driver 102 may include a voltage rail 134, which may be configured to provide a Direct Current (DC) voltage level to the controller 124, e.g., as described below.

In some demonstrative aspects, the power input 118 may be configured to receive DC power from the power source 150, e.g., as described below.

In some demonstrative aspects, the safety-based multi-actuator driver 102 may include a plurality of power rails 136, which may be connected in parallel between the power input 118 and the voltage rail 134, e.g., as described below.

In some demonstrative aspects, a power rail 136 may include a DC to DC (DC-DC) voltage converter (not shown in FIG. 1), which may be configured to convert a voltage of the DC power from the power source 150 to the DC voltage level suitable for the controller 124.

In some demonstrative aspects, controller 124 may be configured, for example, to monitor a functionality of the plurality of power rails 136, e.g., as described below.

In some demonstrative aspects, controller 124 may be configured, for example, to configure the plurality of actuator-drive outputs 117 for the controlled safety-stop, for example, based on a power-rail malfunction event corresponding to a power rail of the plurality of power rails 136, e.g., as described below.

In some demonstrative aspects, the safety-based multi-actuator driver 102 may be configured to provide a technical solution to support a certifiable safety PLC with integrated multi-axis motor drivers for a mobile robot, which may be integrated as one module, e.g., as described below.

In some demonstrative aspects, the safety-based multi-actuator driver 102 may be configured to provide a technical solution to support an SS1-d safety brake of the mobile robot 102.

In some demonstrative aspects, the safety-based multi-actuator driver 102 may be configured to provide a technical solution to support a controlled safety-stop, for example, in more than one axis, for example, two or more axes, e.g., n-axes.

In some demonstrative aspects, the safety-based multi-actuator driver 102 may be configured to provide a technical solution to support certification of the mobile robot 102, for example, according to one or more safety standards, e.g., an IEC61800-5-2 safety standard.

In some demonstrative aspects, the safety-based multi-actuator driver 102 may be configured to provide a technical solution to support safety requirements, e.g., substantially all safety requirements, for a mobile robot, for example, according to an ISO3691-4:2023 safety standard and/or an ANSI R15.08 safety standard.

In some demonstrative aspects, the safety-based multi-actuator driver 102 may be configured to provide a technical solution to support an integrated solution, where substantially all components are integrated in one system or package, for example, to support the functional safety requirements, for example, SS1-d certification requirements.

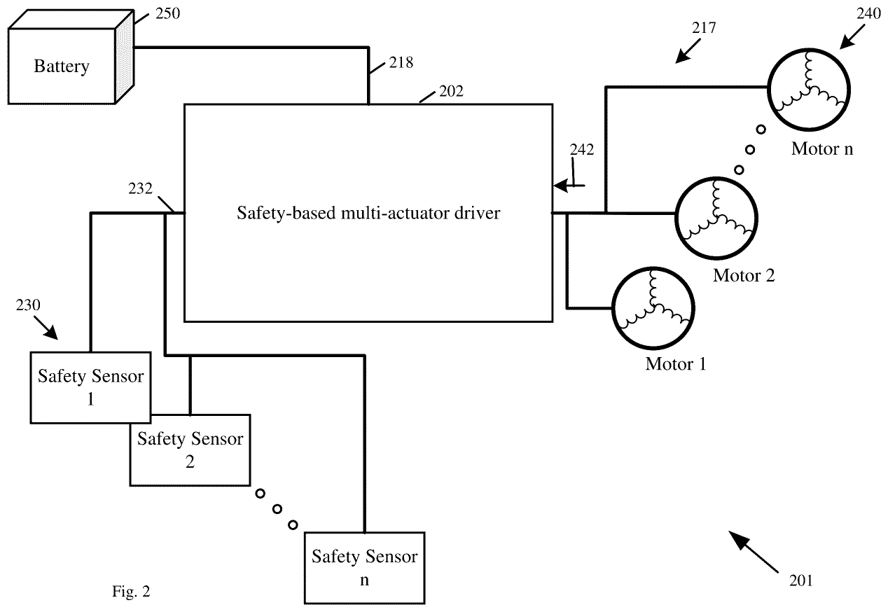

Reference is made to FIG. 2, which schematically illustrates a system 201 including a safety-based multi-actuator driver 202, in accordance with some demonstrative aspects. For example, safety-based multi-actuator driver 102 (FIG. 1) may include one or more elements and/or components of safety-based multi-actuator driver 202, and/or safety-based multi-actuator driver 102 (FIG. 1) may perform one or more operations and/or functionalities of safety-based multi-actuator driver 202.

In some demonstrative aspects, the safety-based multi-actuator driver 202 may be configured to provide a technical solution to support safety certification of a mobile robot, for example, according to a functional safety standard for SS1-d.

In some demonstrative aspects, as shown in FIG. 2, the safety-based multi-actuator driver 202 may be implemented as a functional-safety-complied controller, which may be in compliance with a functional safety standard for SS1-d safety stop for mobile robots.

In some demonstrative aspects, the safety-based multi-actuator driver 202 may be implemented as an integrated safety-based multi-actuator driver including a package integrating the one or more safety-sensor inputs 112 (FIG. 1), the plurality of actuator drivers 122 (FIG. 1), the plurality of driver outputs 116 (FIG. 1), the plurality of monitoring inputs 114 (FIG. 1), the power input 118 (FIG. 1), and/or the controller 124 (FIG. 1).

In some demonstrative aspects, as shown in FIG. 2, safety-based multi-actuator driver 202 may be configured to drive a plurality of actuators 240, e.g., motors, of a plurality of wheels of a mobile robot.

In some demonstrative aspects, as shown in FIG. 2, the safety-based multi-actuator driver 202 may be configured to provide a plurality of actuator-drive outputs 217 to drive the plurality of actuators 240.

In some demonstrative aspects, as shown in FIG. 2, the safety-based multi-actuator driver 202 may be configured to receive safety-sensor information 232 from one or more safety sensors 230 of the mobile robot.

In some demonstrative aspects, the safety-based multi-actuator driver 202 may be configured to control the plurality of actuator-drive outputs 217 for a controlled safety-stop of the mobile robot, for example, based on a sensor-based event, which may be indicated, e.g., identified, by the safety-sensor information 232.

In some demonstrative aspects, the safety-based multi-actuator driver 202 may be configured to receive actuator monitoring information 242 corresponding to a functionality of the plurality of actuators 240.

In some demonstrative aspects, the safety-based multi-actuator driver 202 may be configured to configure the plurality of actuator-drive outputs 217 for the controlled safety-stop, for example, based on an actuator malfunction event, which may be indicated, e.g., identified, by the actuator monitoring information 242.

In some demonstrative aspects, as shown in FIG. 2, the safety-based multi-actuator driver 202 may include a power input 218, for example, to receive power from a power source 250.

In some demonstrative aspects, the safety-based multi-actuator driver 202 may be configured to monitor the power input 218.

In some demonstrative aspects, the safety-based multi-actuator driver 202 may be configured to configure the plurality of actuator-drive outputs 217 for the controlled safety-stop, for example, based on a power-source malfunction event corresponding to the power input 218.

In some demonstrative aspects, the safety-based multi-actuator driver 202 may be configured to drive the plurality of actuators 240 for the controlled safety-stop, for example, such that the mobile robot may decelerate to a stop, e.g., a halt, for example, at a deceleration, which may satisfy applicable functional safety standard requirements of the SS1-d safety stop.

In some demonstrative aspects, the safety-based multi-actuator driver 202 may be configured to configure the plurality of actuator-drive outputs 217 for the controlled safety-stop, for example, such that the controlled safety-stop may be performed according to a velocity vector, which may follow a selected path, e.g., a deliberately selected path.

In one example, a trajectory of the selected path may be predefined.

In another example, the trajectory of the selected path may be based on a last available path input, e.g., a trajectory of the mobile robot immediately prior to triggering the controlled safety stop.

In another example, the trajectory of the selected path may be adjusted in real time, for example, based on sensors and/or programmed logic.

In another example, the trajectory of the selected path may include any other additional and/or alternative path, for example, a trajectory which may be defined by a user or a manufacturer of a mobile robot.

In some demonstrative aspects, the safety-based multi-actuator driver 202 may include dual Micro Control Units (MCUs), e.g., including controller 126 (FIG. 1) and controller 128 (FIG. 1), which may be configured to control a motion of the mobile robot, e.g., as described below.

In some demonstrative aspects, the safety-based multi-actuator driver 202 may include actuator drivers, e.g., the plurality of actuator drivers 122 (FIG. 1), which may be configured to control, e.g., directly or indirectly, one or more actuators, e.g., motors, of the mobile robot, for example, to control motion of the mobile robot in one or more Degrees of Freedom (DoF).

In some demonstrative aspects, the safety-based multi-actuator driver 202 may include one or more inputs, e.g., safety-sensor inputs 112 (FIG. 1), the plurality of monitoring inputs 114 (FIG. 1), and the power input 118 (FIG. 1), from one or more input devices, e.g., the plurality of sensors 230, encoders, switches, and/or the like.

In some demonstrative aspects, the safety-based multi-actuator driver 202 may be configured to generate and/or configure the plurality of actuator-drive outputs 217 according to an open loop control scheme, a closed-loop control scheme, a Proportional-Integral-Derivative (PID) control scheme, an optimal control scheme, an adaptive control scheme, and/or any other suitable additional or alternative control scheme.

In some demonstrative aspects, the safety-based multi-actuator driver 202 may be configured to provide a technical solution to support a successfully controlled safety-stop, for example, in case of a systematic failure, an internal failure, and/or an external trigger from a safety sensor, e.g., as described below.

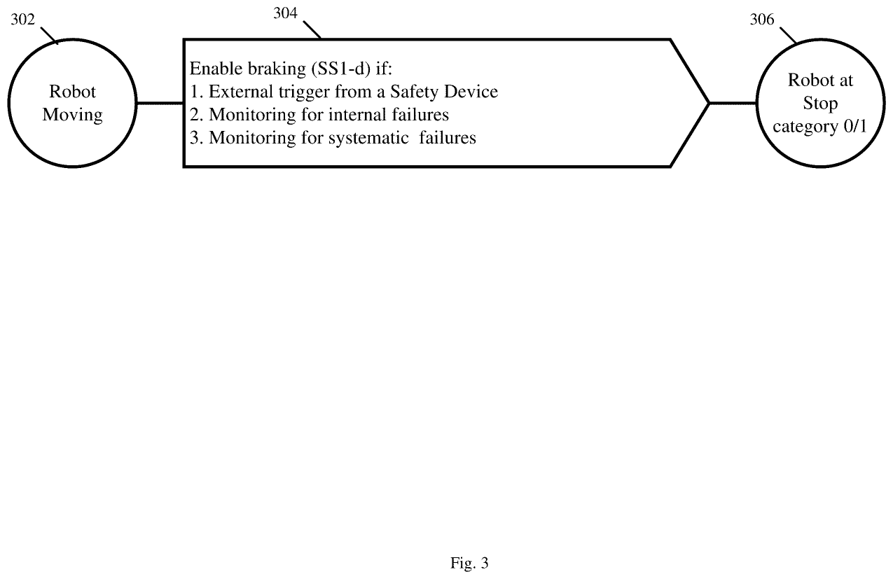

Reference is made to FIG. 3, which schematically illustrates a method of a controlled safety-stop of a mobile robot, in accordance with some demonstrative aspects. For example, one or more of the operations of the method of FIG. 3 may be performed by one or more elements of a mobile robot, e.g., mobile robot 101 (FIG. 1) and/or mobile robot 201 (FIG. 1), a safety-based multi-actuator driver, e.g., the safety-based multi-actuator driver 102 (FIG. 1) and/or the safety-based multi-actuator driver 202 (FIG. 2), and/or a controller, e.g., controller 124 (FIG. 1).

In some demonstrative aspects, as indicated at block 302, the method may include controlling a movement of the robot. For example, safety-based multi-actuator driver 102 (FIG. 1) may control motion of the mobile robot 101 (FIG. 1).

In some demonstrative aspects, as indicated at block 304, the method may include determining that a controlled safety-stop of the mobile robot is to be triggered, for example, based on one or more conditions. For example, the safety-based multi-actuator driver 102 (FIG. 1) and/or the safety-based multi-actuator driver 202 (FIG. 2) may be configured to trigger the controlled safety-stop of the mobile robot 101 (FIG. 1), for example, based on one or more event and/or conditions, e.g., as described below.

In some demonstrative aspects, as indicated at block 306, the method may include braking the robot, for example, according to an SS1-d safety stop. For example, the safety-based multi-actuator driver 102 (FIG. 1) and/or the safety-based multi-actuator driver 202 (FIG. 2) may be configured to control braking of the mobile robot 101 (FIG. 1), for example, according to the SS1-d safety stop, e.g., as described above.

In some demonstrative aspects, as indicated at block 304, a safety-based multi-actuator driver, e.g., safety-based multi-actuator driver 102 (FIG. 1) and/or the safety-based multi-actuator driver 202 (FIG. 2), may be configured to trigger the controlled safety-stop based on an external trigger, e.g., a sensor-based event 113 (FIG. 1), from a safety device, for example, a safety sensor, e.g., a safety sensor 130 (FIG. 1) and/or a safety sensor 240 (FIG. 2).

In some demonstrative aspects, as indicated at block 304, the safety-based multi-actuator driver, e.g., safety-based multi-actuator driver 102 (FIG. 1) and/or the safety-based multi-actuator driver 202 (FIG. 2), may be configured to trigger the controlled safety-stop based on one or more internal failures, e.g., as described below.

In one example, the one or more internal failures may include overcurrent, overvoltage, and/or undervoltage of one or more voltage rails, e.g., power rails 136 (FIG. 1), voltage rail 134 (FIG. 1), and/or the like.

In another example, the one or more internal failures may include a damage in motor circuitry, damage in one or more motor drivers, e.g., damaged transistors, e.g., Field Effect Transistor (FET) or a Gate Driver, and/or the like.

In another example, the one or more internal failures may include an MCU malfunction, e.g., a malfunction of controller 126 (FIG. 1) and/or controller 128 (FIG. 1), and/or the like.

In other aspects, the one or more internal failures may include any other additional/and or alternative failures.

In some demonstrative aspects, as indicated at block 304, the safety-based multi-actuator driver, e.g., safety-based multi-actuator driver 102 (FIG. 1) and/or the safety-based multi-actuator driver 202 (FIG. 2), may be configured to trigger the controlled safety-stop based on one or more systematic failures, e.g., as described below.

In one example, the one or more systematic failures may include disconnection of a battery, e.g., power source 150 (FIG. 1) and/or battery 250 (FIG. 2).

In another example, the one or more systematic failures may include disconnection of a motor phase and/or a damage to the motor phase, and/or the like.

In another example, the one or more systematic failures may include disconnection and/or malfunction of one or more motor encoders, and/or the like.

In other aspects, the one or more systematic failures may include any other additional/and or alternative failures.

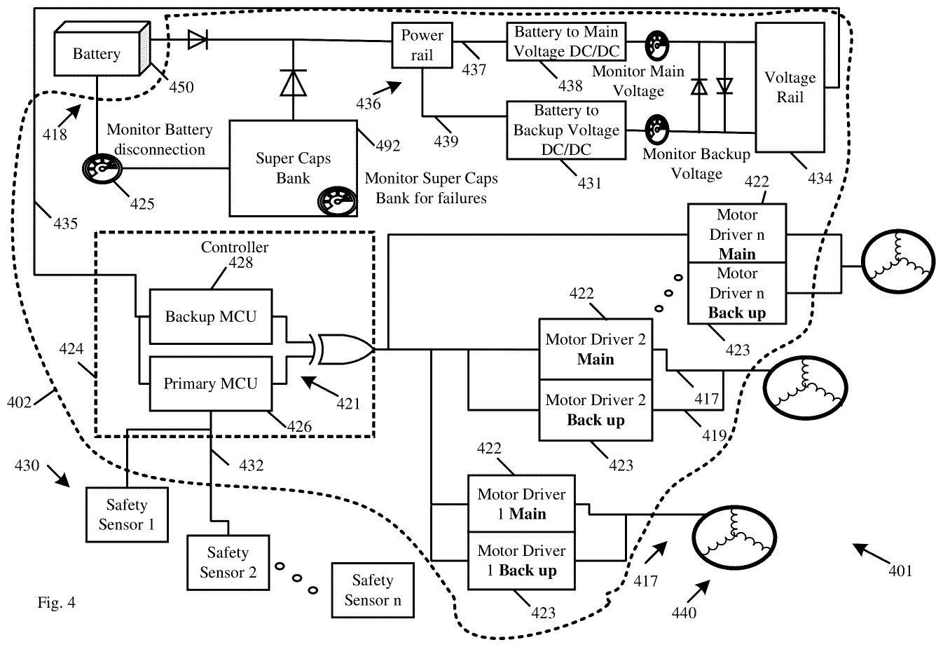

Reference is made to FIG. 4, which schematically illustrates a system 401 implementing an actuator driver redundancy architecture including one or more redundant actuator drivers 423, in accordance with some demonstrative aspects. For example, robot 101 (FIG. 1) may include one or more elements of system 401, and/or may perform one or more operations and/or functionalities of system 401.

In some demonstrative aspects, as shown in FIG. 4, system 401 may include a safety-based multi-actuator driver 402. For example, safety-based multi-actuator driver 102 (FIG. 1) may include one or more elements of safety-based multi-actuator driver 402; and/or may perform one or more operations and/or functionalities of safety-based multi-actuator driver 402.

In some demonstrative aspects, as shown in FIG. 4, the safety-based multi-actuator driver 402 may include an integrated safety-based multi-actuator driver 402.

In some demonstrative aspects, as shown in FIG. 4, safety-based multi-actuator driver 402 may be configured to drive a plurality of actuators 440, e.g., motors, of a plurality of wheels of a mobile robot.

In some demonstrative aspects, as shown in FIG. 4, the safety-based multi-actuator driver 402 may be configured to receive safety-sensor information 432 from one or more safety sensors 430.

In some demonstrative aspects, as shown in FIG. 4, the safety-based multi-actuator driver 402 may be configured to provide a plurality of actuator-drive outputs 417 to drive the plurality of actuators 440.

In some demonstrative aspects, as shown in FIG. 4, the safety-based multi-actuator driver 402 may include a controller 424.

In some demonstrative aspects, as shown in FIG. 4, controller 424 may be configured to control the plurality of actuator-drive outputs 417 for a controlled safety-stop of the mobile robot, for example, based on a sensor-based event, which may be indicated, e.g. identified, by the safety-sensor information 432.

In some demonstrative aspects, as shown in FIG. 4, the safety-based multi-actuator driver 402 may include a plurality of actuator drivers 422, which may be configured to provide the plurality of actuator-drive outputs 417.

In some demonstrative aspects, as shown in FIG. 4, controller 424 may be configured to control the plurality of actuator derivers 422, for example, to provide the plurality of actuator-drive outputs 417, respectively, e.g., as described below.

In some demonstrative aspects, as shown in FIG. 4, the safety-based multi-actuator driver 402 may include a plurality of driver-dedicated backup actuator drivers 423.

In some demonstrative aspects, as shown in FIG. 4, a driver-dedicated backup actuator driver 423 may be connected in parallel to an actuator driver 422 of the plurality of actuator drivers 422.

In some demonstrative aspects, as shown in FIG. 4, the driver-dedicated backup actuator driver 423 may be configured to provide a backup actuator-drive output 419 for the actuator driver 422.

In some demonstrative aspects, as shown in FIG. 4, the safety-based multi-actuator driver 402 may include a power input 418 to receive power from a power source 450, e.g., a battery and/or any other power source.

In some demonstrative aspects, as shown in FIG. 4, the safety-based multi-actuator driver 402 may include a battery monitor 425, which may be configured to monitor the power input 418.

In some demonstrative aspects, as shown in FIG. 4, controller 424 may be configured to configure the plurality of actuator-drive outputs 417 for the controlled safety-stop, for example, based on a power-source malfunction event corresponding to the power input 418, e.g., as indicated or identified by the battery monitor 425.

In some demonstrative aspects, as shown in FIG. 4, the safety-based multi-actuator driver 402 may include an internal power storage 492, which may be connected in parallel to the power input 418.

In some demonstrative aspects, the internal power storage 492 may be configured to store an amount of power sufficient to provide the actuator-drive outputs 417, for example, during the controlled safety-stop.

In some demonstrative aspects, as shown in FIG. 4, the internal power storage 492 may include an SC bank.

In other aspects, the internal power storage 492 may include any other additional or alternative type of power storage.

In some demonstrative aspects, as shown in FIG. 4, the safety-based multi-actuator driver 402 may include a voltage rail 434, which may be configured to provide a DC voltage level 435 to the controller 424.

In some demonstrative aspects, the power input 418 may be configured to receive DC power from the power source 450.

In some demonstrative aspects, as shown in FIG. 4, the safety-based multi-actuator driver 402 may include a plurality of power rails 436, which may be connected in parallel between the power input 418 and the voltage rail 434.

In some demonstrative aspects, as shown in FIG. 4, the plurality of power rails 436 may include a power rail 437 including a DC-DC voltage converter 438.

In some demonstrative aspects, as shown in FIG. 4, DC-DC voltage converter 438 may be configured to convert a voltage of the DC power from power input 418 to the DC voltage level 435.

In some demonstrative aspects, as shown in FIG. 4, the plurality of power rails 436 may include a redundant power rail 439 including a redundant DC-DC voltage converter 431.

In some demonstrative aspects, as shown in FIG. 4, DC-DC voltage converter 431 may be configured to convert a voltage of the power input 418 to the DC voltage level 435.

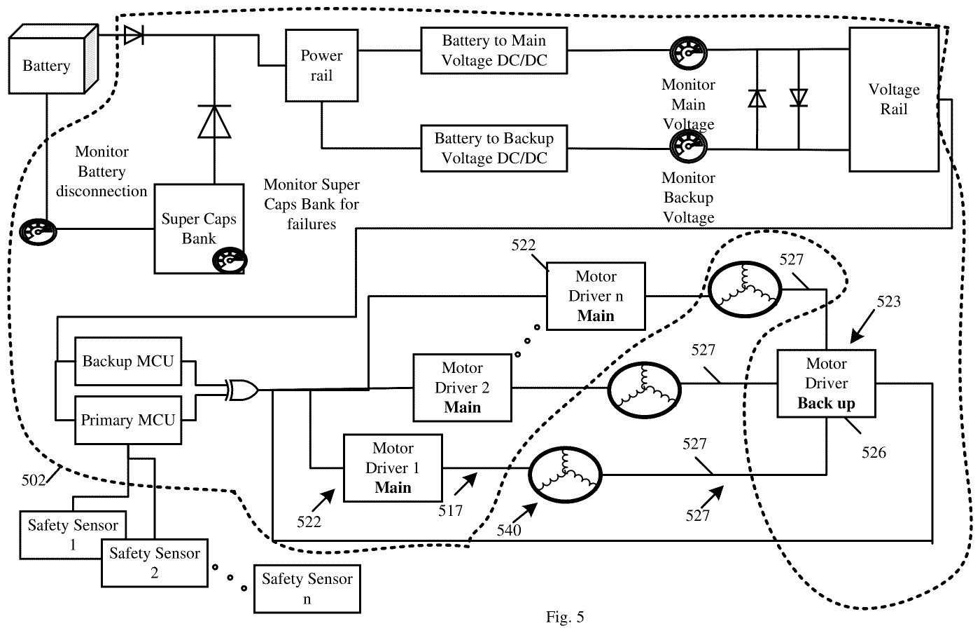

Reference is made to FIG. 5, which schematically illustrates a system 501 implementing an actuator driver redundancy architecture including one or more redundant actuator drivers 523, in accordance with some demonstrative aspects. For example, robot 101 (FIG. 1) may include one or more elements of system 501, and/or may perform one or more operations and/or functionalities of system 501.

In some demonstrative aspects, as shown in FIG. 5, system 501 may include a safety-based multi-actuator driver 502. For example, safety-based multi-actuator driver 102 (FIG. 1) may include one or more elements of safety-based multi-actuator driver 502; and/or may perform one or more operations and/or functionalities of safety-based multi-actuator driver 502.

In some demonstrative aspects, as shown in FIG. 5, the safety-based multi-actuator driver 502 may include an integrated safety-based multi-actuator driver 502.

In some demonstrative aspects, as shown in FIG. 5, safety-based multi-actuator driver 502 may be configured to drive a plurality of actuators 540, e.g., motors, of a plurality of wheels of a mobile robot.

In some demonstrative aspects, as shown in FIG. 5, the safety-based multi-actuator driver 502 may be configured to provide a plurality of actuator-drive outputs 517 to drive the plurality of actuators 540.

In some demonstrative aspects, as shown in FIG. 5, the safety-based multi-actuator driver 502 may include a plurality of actuator drivers 522, which may be configured to provide the plurality of actuator-drive outputs 517.

In some demonstrative aspects, as shown in FIG. 5, the one or more redundant actuator drivers 523 may include a multi-driver backup actuator driver 526, which may be connected in parallel to two or more actuator drivers 522 of the plurality of actuator drivers 522.

In one example, as shown in FIG. 5, the multi-driver backup actuator driver 526 may be connected in parallel to all of the actuator drivers 522.

In other aspects, the multi-driver backup actuator driver 526 may be connected in parallel to only some of the actuator drivers 522.

In some demonstrative aspects, as shown in FIG. 5, the multi-driver backup actuator driver 526 may be configured to provide a backup actuator-drive output 527 for an actuator driver 522 of the two or more actuator drivers 522.

In some demonstrative aspects, as shown in FIG. 5, the multi-driver backup actuator driver 526 may be configured to provide a plurality of backup actuator-drive output 527 for the plurality of actuator drivers 522.

In some demonstrative aspects, as shown in FIG. 5, system 501 may be configured similar to system 401 (FIG. 4), for example, while including a multi-driver backup actuator driver, e.g., the multi-driver backup actuator driver 526, instead of a plurality of driver-dedicated backup actuator drivers, e.g., the plurality of driver-dedicated backup actuator drivers 423 (FIG. 4).

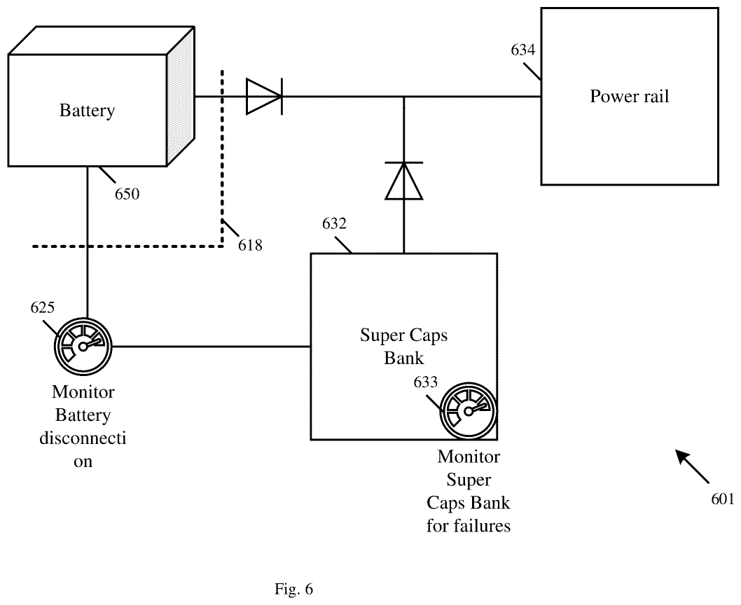

Reference is made to FIG. 6, which schematically illustrates a power source redundancy architecture 601, in accordance with some demonstrative aspects.

In one example, one or more components of power source redundancy architecture 601 may be implemented, for example, as part of a safety-based multi-actuator driver, e.g., safety-based multi-actuator driver 102 (FIG. 1), safety-based multi-actuator driver 202 (FIG. 1), safety-based multi-actuator driver 402 (FIG. 4), and/or safety-based multi-actuator driver 502 (FIG. 5). For example, safety-based multi-actuator driver 102 (FIG. 1) may include one or more elements of power source redundancy architecture 601; and/or may perform one or more operations and/or functionalities of power source redundancy architecture 601.

In some demonstrative aspects, as shown in FIG. 6, power source redundancy architecture 601 may include a power input 618 to receive power from a power source 650, e.g., a battery.

In some demonstrative aspects, as shown in FIG. 6, power source redundancy architecture 601 may include a battery monitor 625, which may be configured to monitor the power input 618. For example, battery monitor 625 may be configured to monitor battery disconnection of power source 650, and/or a power level of power source 650.

In some demonstrative aspects, as shown in FIG. 6, power source redundancy architecture 601 may include an internal power storage 632, which may be connected in parallel to the power input 618.

In some demonstrative aspects, the internal power storage 632 may be configured to store an amount of power sufficient for a controlled safety-stop of a mobile robot, e.g., mobile robot 102 (FIG. 1).

In some demonstrative aspects, as shown in FIG. 6, the internal power storage 632 may include an SC bank.

In other aspects, the internal power storage 632 may include any other additional or alternative type of power storage.

In some demonstrative aspects, as shown in FIG. 6, the power input 618 may be configured to provide DC power from the power source 650 to one or more power rails 634.

In some demonstrative aspects, as shown in FIG. 6, power source redundancy architecture 601 may include an internal-power-storage monitor 633, which may be configured to monitor the internal power storage 632. For example, internal-power-storage monitor 633 may be configured to monitor a power level and/or any other power failure of the internal power storage 632.

For example, a controller, e.g., controller 124 (FIG. 1) may be configured to trigger a controlled safety-stop, for example, based on a power-source malfunction event indicated, e.g., identified, by the battery monitor 625 and/or the internal-power-storage monitor 633.

In some demonstrative aspects, power source redundancy architecture 601 may be configured to provide a technical solution to support a controlled safety-stop of a mobile robot, for example, in case of a failure and/or disconnection of power source 650, for example, by utilizing power from internal power storage 632 as a backup, for example, instead of, or in addition to, any power from the power source 650.

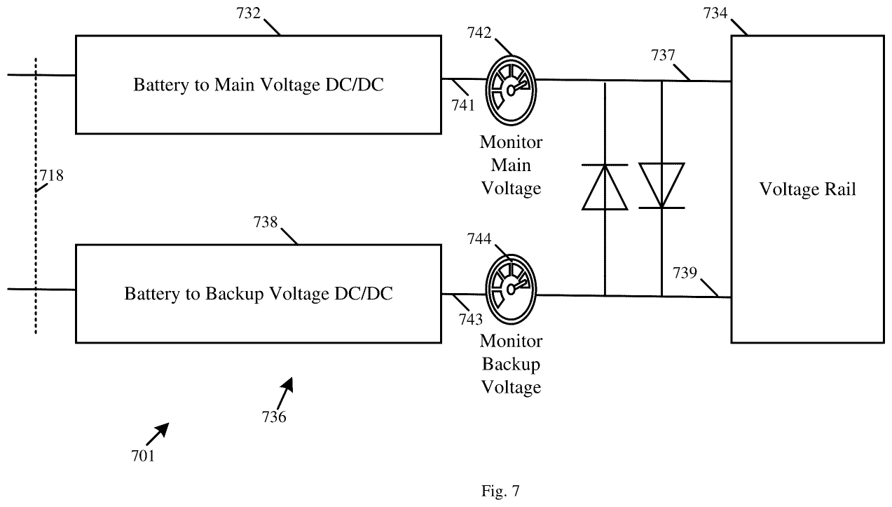

Reference is made to FIG. 7, which schematically illustrates a power rail redundancy architecture 701, in accordance with some demonstrative aspects.

In one example, one or more elements and/or components of power rail redundancy architecture 701 may be implemented, for example, as part of a safety-based multi-actuator driver, e.g., safety-based multi-actuator driver 102 (FIG. 1), safety-based multi-actuator driver 202 (FIG. 1), safety-based multi-actuator driver 402 (FIG. 4), and/or safety-based multi-actuator driver 502 (FIG. 5). For example, safety-based multi-actuator driver 102 (FIG. 1) may include one or more elements of power rail redundancy architecture 701; and/or may perform one or more operations and/or functionalities of power rail redundancy architecture 701.

In some demonstrative aspects, as shown in FIG. 7, power rail redundancy architecture 701 may include a plurality of power rails 736, which may be configured to receive DC power via a power input 718.

some demonstrative aspects, as shown in FIG. 7, power rail redundancy architecture 701 include a voltage rail 734, which may be configured to provide a DC voltage level to a controller, e.g., controller 424 (FIG. 4).

In some demonstrative aspects, as shown in FIG. 7, the plurality of power rails 736 may be connected in parallel between the power input 718 and the voltage rail 734.

In some demonstrative aspects, as shown in FIG. 7, the plurality of power rails 736 may include a power rail 737, which may include a DC-DC voltage converter 732.

In some demonstrative aspects, as shown in FIG. 7, DC-DC voltage converter 732 may be configured to convert a voltage of the power input 718, e.g., from power source 650 (FIG. 6) and/or from internal power storage 632 (FIG. 6), to the DC voltage level for voltage rail 734.

In some demonstrative aspects, as shown in FIG. 7, the plurality of power rails 736 may include a redundant power rail 739, which may include a redundant DC-DC voltage converter 738.

In some demonstrative aspects, as shown in FIG. 7, the redundant DC-DC voltage converter 738 may be configured to convert a voltage of the power input 718, e.g., from power source 650 (FIG. 6) and/or from internal power storage 632 (FIG. 6), to the DC voltage level for voltage rail 734.

In some demonstrative aspects, as shown in FIG. 7, power rail redundancy architecture 701 may include a first voltage monitor 742, which may be configured to monitor an output voltage 741 of DC-DC voltage converter 732.

In some demonstrative aspects, as shown in FIG. 7, power rail redundancy architecture 701 may include a second voltage monitor 744, which may be configured to monitor an output voltage 743 of the redundant DC-DC voltage converter 738.

For example, a controller, e.g., controller 124 (FIG. 1) may be configured to trigger a controlled safety-stop, for example, based on a voltage malfunction event indicated, e.g., identified, by the first voltage monitor 742 and/or the second voltage monitor 744.

In some demonstrative aspects, power rail redundancy architecture 701 may be configured to provide a technical solution to support a controlled safety-stop of a mobile robot, for example, in case of a power supply failure in a power rail, e.g., power rail 737, of the plurality of power rails 736, for example, by utilizing another power rail, e.g., redundant power rail 739, to supply power to voltage rail 734, for example, instead of the failed power rail 737.

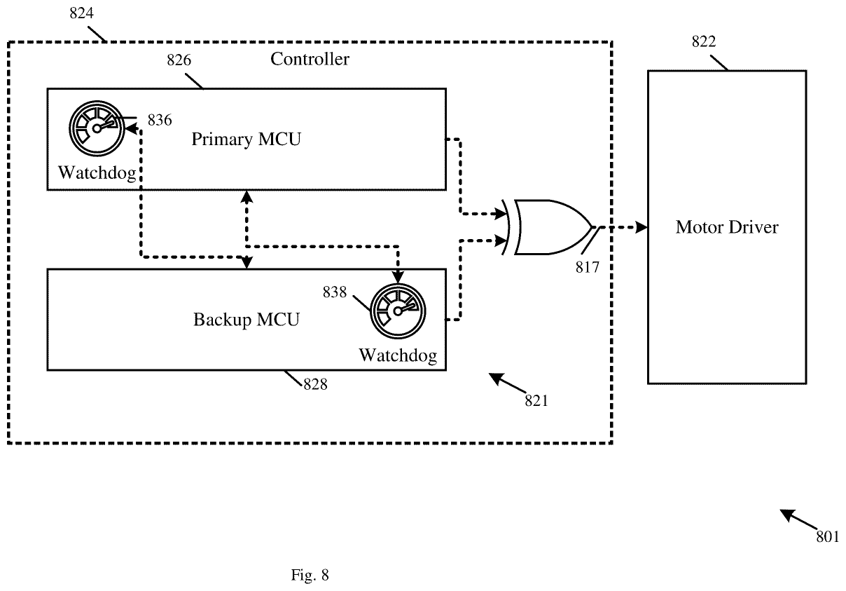

Reference is made to FIG. 8, which schematically illustrates a controller redundancy architecture 801, in accordance with some demonstrative aspects.

In one example, one or more elements and/or components of controller redundancy architecture 801 may be implemented, for example, as part of a safety-based multi-actuator driver, e.g., safety-based multi-actuator driver 102 (FIG. 1), safety-based multi-actuator driver 202 (FIG. 1), safety-based multi-actuator driver 402 (FIG. 4), and/or safety-based multi-actuator driver 502 (FIG. 5). For example, safety-based multi-actuator driver 102 (FIG. 1) may include one or more elements of controller redundancy architecture 801; and/or may perform one or more operations and/or functionalities of controller redundancy architecture 801.

In some demonstrative aspects, as shown in FIG. 8, controller redundancy architecture 801 may include a controller 824. For example, controller 124 (FIG. 1) may include one or more elements of controller 824; and/or may perform one or more operations and/or functionalities of controller 824.

In some demonstrative aspects, as shown in FIG. 8, controller 824 may include a plurality of mutually-monitored controllers 821.

In some demonstrative aspects, as shown in FIG. 8, the plurality of mutually-monitored controllers 821 may include a first controller 826, e.g., a primary controller, which may be configured to configure an actuator-drive output 817 to drive an actuator driver 822, e.g., motor.

In some demonstrative aspects, first controller 826 may be configured to configure the actuator-drive output 817 for a controlled safety-stop of a mobile robot, for example, based on a sensor-based event e.g., as described above.

In some demonstrative aspects, as shown in FIG. 8, the plurality of mutually-monitored controllers 821 may include a second controller 828, e.g., a backup controller, which may be configured to configure the actuator-drive output 817 to drive the actuator driver 822, for example, in case of a malfunction of the first controller 826.

In some demonstrative aspects, second controller 828 may be configured to configure the actuator-drive output 817 for the controlled safety-stop, for example, based on the sensor-based event, for example, in the case of the malfunction of the first controller 826.

In some demonstrative aspects, first controller 826 may be configured to monitor a functionality of the second controller 828.

In some demonstrative aspects, as shown in FIG. 8, controller redundancy architecture 801 may include a controller monitor 838, e.g., a watchdog, which may be configured to monitor the functionality of controller 828.

In some demonstrative aspects, first controller 826 may be configured to configure the actuator-drive output 817 for the controlled safety-stop, for example, based on a malfunction of the second controller 828, which may be indicated, e.g., identified, by controller monitor 838.

In some demonstrative aspects, as shown in FIG. 8, second controller 828 may be configured to monitor a functionality of the first controller 826.

In some demonstrative aspects, as shown in FIG. 8, controller redundancy architecture 801 may include a controller monitor 836, e.g., a watchdog, which may be configured to monitor the functionality of controller 826.

In some demonstrative aspects, second controller 828 may be configured to configure the actuator-drive output 817 for the controlled safety-stop, for example, based on a malfunction of the first controller 826, which may be indicated, e.g., identified, by controller monitor 836.

In some demonstrative aspects, the first controller 826, e.g., the primary controller, may be configured to monitor one or more internal failures and/or one or more systematic failures, for example, at one or more predefined tie slots, e.g., periodically.

In some demonstrative aspects, the second controller 828, e.g., the backup controller, may be configured to monitor the first controller 826, and to control the controlled safety-stop, for example, in case of a malfunction of the first controller 826.

In some demonstrative aspects, the second controller 828 may be implemented to have one or more, e.g., some or all, functionalities similar to the first controller 826, e.g., based on a hardware duplication.

In some demonstrative aspects, the second controller 828 may include a simple controller, e.g., a degraded controller, for example, compared to the first controller 826, which may be able to perform only some of the functionalities of the first controller 826, e.g., at least the functionalities required for controlling the controlled safety stop.

In some demonstrative aspects, the second controller 828 may include one or more extended features, which may not be safety related.

In some demonstrative aspects, controller 824 may support a watchdog functionality, for example, by mutual monitoring between, e.g., by the controller monitor 836 and the controller monitor 838, the controller 826 and controller 828, for example, instead of a full HW redundancy, e.g., by a HW duplication.

In some demonstrative aspects, controller redundancy architecture 801 may be configured to provide a technical solution to support a controlled safety-stop of a mobile robot, for example, in case of a controller failure of a primary controller, e.g., controller 826, for example, by utilizing a backup controller, e.g., controller 828, to configure the actuator-drive output 817, for example, as a backup to the first controller 826.

In some demonstrative aspects, controller 824 may be configured to configure the actuator-drive output 817 for the controlled safety-stop, for example, based on an actuator driver malfunction event corresponding to the actuator driver 822.

In some demonstrative aspects, the actuator driver malfunction event may include a half-bridge driver malfunction event corresponding to a half-bridge driver of the actuator driver 822.

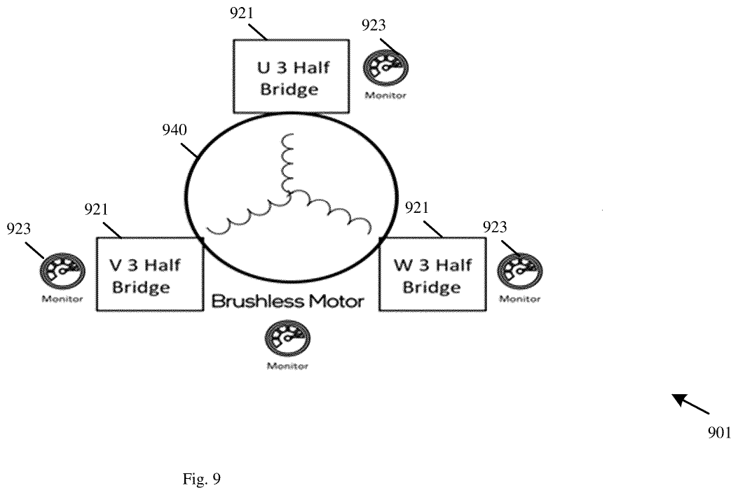

Reference is made to FIG. 9, which schematically illustrates a half-bridge driver redundancy architecture 901, in accordance with some demonstrative aspects.

In one example, one or more components and/or elements of half-bridge driver redundancy architecture 901 may be implemented, for example, as part of a safety-based multi-actuator driver, e.g., safety-based multi-actuator driver 102 (FIG. 1), safety-based multi-actuator driver 202 (FIG. 1), safety-based multi-actuator driver 402 (FIG. 4), and/or safety-based multi-actuator driver 502 (FIG. 5). For example, safety-based multi-actuator driver 102 (FIG. 1) may include one or more elements of half-bridge driver redundancy architecture 901; and/or may perform one or more operations and/or functionalities of half-bridge driver redundancy architecture 901.

In some demonstrative aspects, half-bridge driver redundancy architecture 901 may be configured to monitor a half-bridge driver malfunction of a driver of an actuator 940.

In some demonstrative aspects, as shown in FIG. 9, actuator 940 may be driven by a plurality of actuator driver phases 921, e.g., three actuator driver phases 921.

In some demonstrative aspects, as shown in FIG. 9, half-bridge driver redundancy architecture 901 may include a plurality of actuator driver phase monitors 923, e.g., three actuator driver phase monitors 923, which may be configured to monitor the plurality of actuator driver phases 921, respectively.

In some demonstrative aspects, a controller, e.g., controller 124 (FIG. 1), may be configured to monitor the functionality of the plurality of actuator driver phases 921 based on information from the plurality of actuator driver phase monitors 923. For example, the controller, e.g., controller 124 (FIG. 1), may be configured, for example, to configure a plurality of actuator-drive outputs, e.g., the plurality of actuator-drive outputs 117 (FIG. 1), for the controlled safety-stop, for example, based on an actuator driver malfunction event corresponding to the plurality of actuator driver phases 921.

In some demonstrative aspects, half-bridge driver redundancy architecture 901 may be configured to provide a technical solution to support a controlled safety-stop of a mobile robot, for example, in case of a half-bridge driver malfunction, e.g., a disconnection or a malfunction of a phase, of one actuator driver phase 921, for example, by utilizing the other two actuator driver phases 921 of the plurality of actuator driver phases 921 for the controlled safety-stop.

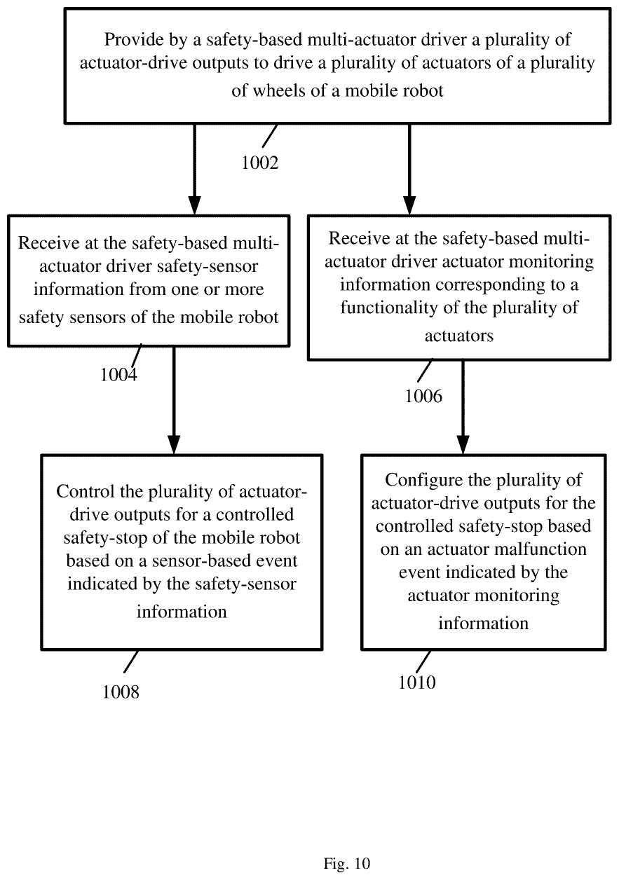

Reference is made to FIG. 10, which schematically illustrates a method of a safety-based multi-actuator driver, in accordance with some demonstrative aspects. For example, one or more of the operations of the method of FIG. 10 may be performed by one or more elements of a mobile robot, e.g., mobile robot 101 (FIG. 1), mobile robot 201 (FIG. 2), a safety-based multi-actuator driver, e.g., the safety-based multi-actuator driver 102 (FIG. 1) and/or the safety-based multi-actuator driver 202 (FIG. 2), and/or a controller, e.g., controller 124 (FIG. 1).

In some demonstrative aspects, as indicated at block 1002, the method may include providing from a safety-based multi-actuator driver a plurality of actuator-drive outputs to drive a plurality of actuators of a plurality of wheels of a mobile robot. For example, safety-based multi-actuator driver 102 (FIG. 1) may be configured to provide, e.g., via the plurality of driver outputs 116 (FIG. 1), the plurality of actuator-drive outputs 117 (FIG. 1) to drive the plurality of actuators 140 (FIG. 1) of the plurality of wheels 149 (FIG. 1) of the mobile robot 101 (FIG. 1), e.g., as described above.

In some demonstrative aspects, as indicated at block 1004, the method may include receiving at the safety-based multi-actuator driver safety-sensor information from one or more safety sensors of the mobile robot. For example, safety-based multi-actuator driver 102 (FIG. 1) may be configured to receive, e.g., via the one or more safety-sensor inputs 112 (FIG. 1), the safety-sensor information 132 (FIG. 1) from the one or more safety sensors 130 (FIG. 1) of the mobile robot 101 (FIG. 1), e.g., as described above.

In some demonstrative aspects, as indicated at block 1006, the method may include receiving at the safety-based multi-actuator driver actuator monitoring information corresponding to a functionality of the plurality of actuators. For example, safety-based multi-actuator driver 102 (FIG. 1) may be configured to receive, e.g., via the plurality of monitoring inputs 114 (FIG. 1), the actuator monitoring information 142 (FIG. 1) corresponding to the functionality of the plurality of actuators 140 (FIG. 1), e.g., as described above.

In some demonstrative aspects, as indicated at block 1008, the method may include controlling the plurality of actuator-drive outputs for a controlled safety-stop of the mobile robot based on a sensor-based event indicated, e.g., identified, by the safety-sensor information. For example, controller 124 (FIG. 1) may be configured to control the plurality of actuator-drive outputs 117 (FIG. 1) for the controlled safety-stop of the mobile robot 101 (FIG. 1), for example, based on the sensor-based event 113 (FIG. 1) indicated by the safety-sensor information 132 (FIG. 1), e.g., as described above.

In some demonstrative aspects, as indicated at block 1010, the method may include configuring the plurality of actuator-drive outputs for the controlled safety-stop based on an actuator malfunction event indicated, e.g., identified, by the actuator monitoring information. For example, controller 124 (FIG. 1) may be configured to configure the plurality of actuator-drive outputs 117 (FIG. 1) for the controlled safety-stop, for example, based on the actuator malfunction event 115 (FIG. 1) indicated, e.g., identified, by the actuator monitoring information 142 (FIG. 1), e.g., as described above.

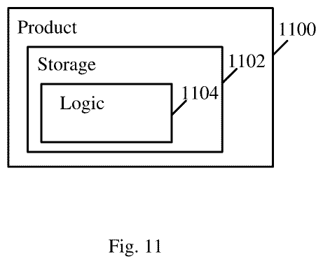

Reference is made to FIG. 11, which schematically illustrates a product of manufacture 1100, in accordance with some demonstrative aspects. Product 1100 may include one or more tangible computer-readable (“machine-readable”) non-transitory storage media 1102, which may include computer-executable instructions, e.g., implemented by logic 1104, operable to, when executed by at least one processor, enable the at least one processor to implement one or more operations at a mobile robot, e.g., mobile robot 101 (FIG. 1) and/or mobile robot 201 (FIG. 2) a safety-based multi-actuator driver, e.g., safety-based multi-actuator driver 102 (FIG. 1), safety-based multi-actuator driver 202 (FIG. 2), safety-based multi-actuator driver 402 (FIG. 4), and/or safety-based multi-actuator driver 502 (FIG. 5), and/or a controller, e.g., controller 124 (FIG. 1), controller 126 (FIG. 1), and/or controller 128 (FIG. 1); to cause a mobile robot, e.g., mobile robot 101 (FIG. 1) and/or mobile robot 201 (FIG. 2), a safety-based multi-actuator driver, e.g., safety-based multi-actuator driver 102 (FIG. 1), safety-based multi-actuator driver 202 (FIG. 2), safety-based multi-actuator driver 402 (FIG. 4), and/or safety-based multi-actuator driver 502 (FIG. 5), and/or a controller, e.g., controller 124 (FIG. 1), controller 126 (FIG. 1), and/or controller 128 (FIG. 1) to perform, trigger and/or implement one or more operations and/or functionalities; and/or to perform, trigger and/or implement one or more operations and/or functionalities described with reference to the FIGS. 1-10, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1100 and/or machine readable storage media 1102 may include one or more types of computer-readable storage media capable of storing data, including volatile memory, non-volatile memory, removable or non-removable memory, erasable or non-erasable memory, writeable or re-writeable memory, and the like. For example, machine readable storage media 1102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The Following Examples Pertain to Further Aspects.
Example 1 includes an apparatus for a mobile robot, the apparatus comprising a safety-based multi-actuator driver configured to drive a plurality of actuators of a plurality of wheels of the mobile robot, the safety-based multi-actuator driver comprising one or more safety-sensor inputs to receive safety-sensor information from one or more safety sensors of the mobile robot; a plurality of driver outputs to provide a plurality of actuator-drive outputs to drive the plurality of actuators; a plurality of monitoring inputs to receive actuator monitoring information corresponding to a functionality of the plurality of actuators; and a controller to control the plurality of actuator-drive outputs for a controlled safety-stop of the mobile robot based on a sensor-based event identified based on the safety-sensor information, and to configure the plurality of actuator-drive outputs for the controlled safety-stop based on an actuator malfunction event identified based on the actuator monitoring information.
Example 2 includes the subject matter of Example 1, and optionally, wherein the safety-based multi-actuator driver comprises a plurality of actuator drivers, wherein the controller is to control the plurality of actuator derivers to provide the plurality of actuator-drive outputs, respectively.
Example 3 includes the subject matter of Example 2, and optionally, wherein the safety-based multi-actuator driver comprises one or more redundant actuator drivers configured to provide the plurality of actuator-drive outputs.
Example 4 includes the subject matter of Example 3, and optionally, wherein the one or more redundant actuator drivers comprises a driver-dedicated backup actuator driver connected in parallel to an actuator driver of the plurality of actuator drivers, the driver-dedicated backup actuator driver to provide a backup actuator-drive output for the actuator driver.
Example 5 includes the subject matter of Example 3 or 4, and optionally, wherein the one or more redundant actuator drivers comprises a multi-driver backup actuator driver connected in parallel to two or more actuator drivers of the plurality of actuator drivers, the multi-driver backup actuator driver to provide a backup actuator-drive output for an actuator driver of the two or more actuator drivers.
Example 6 includes the subject matter of any one of Examples 2-5, and optionally, wherein the controller is configured to monitor a functionality of the plurality of actuator drivers, and to configure the plurality of actuator-drive outputs for the controlled safety-stop based on an actuator driver malfunction event corresponding to an actuator driver of the plurality of actuator drivers.
Example 7 includes the subject matter of Example 6, and optionally, wherein the actuator driver malfunction event comprises a half-bridge driver malfunction event corresponding to a half-bridge driver of the actuator driver.
Example 8 includes the subject matter of any one of Examples 1-7, and optionally, wherein the controller comprises a plurality of mutually-monitored controllers comprising a first controller to configure the plurality of actuator-drive outputs for the controlled safety-stop based on the sensor-based event, and to configure the plurality of actuator-drive outputs for the controlled safety-stop based on the actuator malfunction event; and a second controller to configure the plurality of actuator-drive outputs for the controlled safety-stop based on the sensor-based event, and to configure the plurality of actuator-drive outputs for the controlled safety-stop based on the actuator malfunction event, wherein the first controller is to monitor a functionality of the second controller and to configure the plurality of actuator-drive outputs for the controlled safety-stop based on a malfunction of the second controller, wherein the second controller is to monitor a functionality of the first controller and to configure the plurality of actuator-drive outputs for the controlled safety-stop based on a malfunction of the first controller.
Example 9 includes the subject matter of any one of Examples 1-8, and optionally, wherein the safety-based multi-actuator driver comprises a power input to receive power from a power source; and an internal power storage connected in parallel to the power input, the internal power storage to store an amount of power sufficient to provide the actuator-drive outputs during the controlled safety-stop.
Example 10 includes the subject matter of Examples 9, and optionally, wherein the internal power storage comprises a capacitor bank.
Example 11 includes the subject matter of Examples 9 or 10, and optionally, wherein the internal power storage comprises a Super Capacitor (SC) bank.
Example 12 includes the subject matter of any one of Examples 1-11, and optionally, wherein the safety-based multi-actuator driver comprises a power input to receive Direct Current (DC) power from a power source; a voltage rail to provide a DC voltage level to the controller; and a plurality of power rails connected in parallel between the power input and the voltage rail, wherein a power rail comprises a DC to DC (DC-DC) voltage converter to convert a voltage of the DC power to the DC voltage level.
Example 13 includes the subject matter of Example 12, and optionally, wherein the controller is configured to monitor a functionality of the plurality of power rails, and to configure the plurality of actuator-drive outputs for the controlled safety-stop based on a power-rail malfunction event corresponding to a power rail of the plurality of power rails.
Example 14 includes the subject matter of any one of Examples 1-13, and optionally, wherein the safety-based multi-actuator driver comprises a power input to receive power from a power source, wherein the controller is configured to monitor the power input, and to configure the plurality of actuator-drive outputs for the controlled safety-stop based on a power-source malfunction event corresponding to the power input.
Example 15 includes the subject matter of any one of Examples 1-14, and optionally, wherein the controlled safety stop comprises a category 1 deceleration-controlled safety stop (SS1-d).
Example 16 includes the subject matter of any one of Examples 1-15, and optionally, wherein the safety-based multi-actuator driver comprises an integrated safety-based multi-actuator driver comprising a package integrating the one or more safety-sensor inputs, a plurality of actuator drivers to provide the plurality of actuator-drive outputs, the plurality of driver outputs, the plurality of monitoring inputs, and the controller.
Example 17 includes the subject matter of any one of Examples 1-16, and optionally, wherein the safety-based multi-actuator driver is a functional-safety-complied controller in compliance with a functional safety standard for category 1 deceleration-controlled safety stop (SS1-d) for mobile robots.
Example 18 comprises an apparatus comprising means for executing any of the described operations of Examples 1-17.
Example 19 comprises a multi-actuator driver configured to perform any of the described operations of Examples 1-17.
Example 20 comprises a mobile robot configured to perform any of the described operations of Examples 1-17.
Example 21 comprises a product comprising one or more tangible computer-readable non-transitory storage media comprising instructions operable to, when executed by at least one processor, enable the at least one processor to cause any of the described operations of Examples 1-17.
Example 22 comprises an apparatus comprising: a memory interface; and processing circuitry configured to: perform any of the described operations of Examples 1-17.
Example 23 comprises a method comprising any of the described operations of Examples 1-17.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus for a mobile robot, the apparatus comprising:
a safety-based multi-actuator driver configured to drive a plurality of actuators of a plurality of wheels of the mobile robot, the safety-based multi-actuator driver comprising:
one or more safety-sensor inputs to receive safety-sensor information from one or more safety sensors of the mobile robot;
a plurality of driver outputs to provide a plurality of actuator-drive outputs to drive the plurality of actuators;
a plurality of monitoring inputs to receive actuator monitoring information corresponding to a functionality of the plurality of actuators; and
a controller to control the plurality of actuator-drive outputs for a controlled safety-stop of the mobile robot based on a sensor-based event identified based on the safety-sensor information, and to configure the plurality of actuator-drive outputs for the controlled safety-stop based on an actuator malfunction event identified based on the actuator monitoring information.

2. The apparatus of claim 1, wherein the safety-based multi-actuator driver comprises a plurality of actuator drivers, wherein the controller is to control the plurality of actuator derivers to provide the plurality of actuator-drive outputs, respectively.

3. The apparatus of claim 2, wherein the safety-based multi-actuator driver comprises one or more redundant actuator drivers configured to provide the plurality of actuator-drive outputs.

4. The apparatus of claim 3, wherein the one or more redundant actuator drivers comprises a driver-dedicated backup actuator driver connected in parallel to an actuator driver of the plurality of actuator drivers, the driver-dedicated backup actuator driver to provide a backup actuator-drive output for the actuator driver.

5. The apparatus of claim 3, wherein the one or more redundant actuator drivers comprises a multi-driver backup actuator driver connected in parallel to two or more actuator drivers of the plurality of actuator drivers, the multi-driver backup actuator driver to provide a backup actuator-drive output for an actuator driver of the two or more actuator drivers.

6. The apparatus of claim 2, wherein the controller is configured to monitor a functionality of the plurality of actuator drivers, and to configure the plurality of actuator-drive outputs for the controlled safety-stop based on an actuator driver malfunction event corresponding to an actuator driver of the plurality of actuator drivers.

7. The apparatus of claim 6, wherein the actuator driver malfunction event comprises a half-bridge driver malfunction event corresponding to a half-bridge driver of the actuator driver.

8. The apparatus of claim 1, wherein the controller comprises a plurality of mutually-monitored controllers comprising:
a first controller to configure the plurality of actuator-drive outputs for the controlled safety-stop based on the sensor-based event, and to configure the plurality of actuator-drive outputs for the controlled safety-stop based on the actuator malfunction event; and
a second controller to configure the plurality of actuator-drive outputs for the controlled safety-stop based on the sensor-based event, and to configure the plurality of actuator-drive outputs for the controlled safety-stop based on the actuator malfunction event,
wherein the first controller is to monitor a functionality of the second controller and to configure the plurality of actuator-drive outputs for the controlled safety-stop based on a malfunction of the second controller,
wherein the second controller is to monitor a functionality of the first controller and to configure the plurality of actuator-drive outputs for the controlled safety-stop based on a malfunction of the first controller.

9. The apparatus of claim 1, wherein the safety-based multi-actuator driver comprises:
a power input to receive power from a power source; and
an internal power storage connected in parallel to the power input, the internal power storage to store an amount of power sufficient to provide the actuator-drive outputs during the controlled safety-stop.

10. The apparatus of claims 9, wherein the internal power storage comprises a capacitor bank.

11. The apparatus of claims 9, wherein the internal power storage comprises a Super Capacitor (SC) bank.

12. The apparatus of claim 1, wherein the safety-based multi-actuator driver comprises:
a power input to receive Direct Current (DC) power from a power source;
a voltage rail to provide a DC voltage level to the controller; and
a plurality of power rails connected in parallel between the power input and the voltage rail, wherein a power rail comprises a DC to DC (DC-DC) voltage converter to convert a voltage of the DC power to the DC voltage level.

13. The apparatus of claim 12, wherein the controller is configured to monitor a functionality of the plurality of power rails, and to configure the plurality of actuator-drive outputs for the controlled safety-stop based on a power-rail malfunction event corresponding to a power rail of the plurality of power rails.

14. The apparatus of claim 1, wherein the safety-based multi-actuator driver comprises a power input to receive power from a power source, wherein the controller is configured to monitor the power input, and to configure the plurality of actuator-drive outputs for the controlled safety-stop based on a power-source malfunction event corresponding to the power input.

15. The apparatus of claim 1, wherein the controlled safety stop comprises a category 1 deceleration-controlled safety stop (SS1-d).

16. The apparatus of claim 1, wherein the safety-based multi-actuator driver comprises an integrated safety-based multi-actuator driver comprising a package integrating the one or more safety-sensor inputs, a plurality of actuator drivers to provide the plurality of actuator-drive outputs, the plurality of driver outputs, the plurality of monitoring inputs, and the controller.

17. The apparatus of claim 1, wherein the safety-based multi-actuator driver is a functional-safety-complied controller in compliance with a functional safety standard for category 1 deceleration-controlled safety stop (SS1-d) for mobile robots.

18. A mobile robot comprising:
a plurality of wheels;
a plurality of actuators to rotate the plurality of wheels;
one or more safety sensors; and
a safety-based multi-actuator driver configured to drive the plurality of actuators, the safety-based multi-actuator driver comprising:
one or more safety-sensor inputs to receive safety-sensor information from the one or more safety sensors;
a plurality of driver outputs to provide a plurality of actuator-drive outputs to drive the plurality of actuators;
a plurality of monitoring inputs to receive actuator monitoring information corresponding to a functionality of the plurality of actuators; and
a controller to control the plurality of actuator-drive outputs for a controlled safety-stop of the mobile robot based on a sensor-based event identified based on the safety-sensor information, and to configure the plurality of actuator-drive outputs for the controlled safety-stop based on an actuator malfunction event identified based on the actuator monitoring information.

19. The mobile robot of claim 18, wherein the safety-based multi-actuator driver comprises a plurality of actuator drivers, wherein the controller is to control the plurality of actuator derivers to provide the plurality of actuator-drive outputs, respectively.

20. The mobile robot of claim 18, wherein the safety-based multi-actuator driver comprises an integrated safety-based multi-actuator driver comprising a package integrating the one or more safety-sensor inputs, a plurality of actuator drivers to provide the plurality of actuator-drive outputs, the plurality of driver outputs, the plurality of monitoring inputs, and the controller.
